(19) United States
(12) Patent Application Publication
(10) Pub. No.: US 2017/0073194 A1
(43) Pub. Date: Mar. 16, 2017

(54) ELEVATOR DOOR SYSTEM

(71) Applicant: Otis Elevator Company, Farmington, CT (US)

(72) Inventor: JongChan Mun, Seoul (KR)

(21) Appl. No.: 15/264,154

(22) Filed: Sep. 13, 2016

Related U.S. Application Data
(60) Provisional application No. 62/218,046, filed on Sep. 14, 2015.

(51) Int. Cl. B66B 13/24; B66B 13/30

(52) U.S. Cl. CPC B66B 13/24; B66B 13/301

(57) ABSTRACT

An elevator door system includes at least one elevator door; a guide bracket mounted to a bottom of the at least one elevator door; a threshold having a groove to receive the guide bracket; a retention bracket coupled to the threshold, the retention bracket positioned in a hoistway and behind the door, the retention bracket located proximate to a door jamb.

### CROSS-REFERENCE TO RELATED APPLICATIONS

This application claims the benefit of U.S. provisional patent application Ser. No. 62/218,046, filed Sep. 14, 2015, the entire contents of which are incorporated herein by reference.

### BACKGROUND

The present disclosure relates generally to elevator systems, and in particular, to a protection device to prevent an elevator door from being dislodged into a hoistway.

Elevator landing doors typically include a mechanism to prevent the doors from being pushed inward into the hoistway. FIGS. 1A and 1B depict an existing door protection mechanism in which a guide 20 is secured to a bottom edge of a landing door 10. The guide 20 includes a guide bracket 21 secured to the door 10 by a fastener. The guide includes a guide shoe 22 that travels in a groove formed in a sill or threshold 30. As shown in FIGS. 2A and 2B, if excessive force is applied to door 10 in a direction perpendicular to the open/close direction of door 10, then the guide shoe 22 may be forced from the groove in threshold 30. This allows the door 10 to swing into the hoistway.

FIGS. 3-5 depict one example of a system to improve retention between the door and the sill. FIGS. 3-5 are similar to a protecting device disclosed in International Patent Publication Number WO2008/143378, the entire contents of which are incorporated herein by reference. FIGS. 3-5 depict locking device 41 disposed in a groove 1 of a guide rail 2. The locking device 41 receives a push-resistant device 30 attached to the door to prevent the door from being dislodged from the guide rail.

While the devices of FIGS. 1-5 are well suited for their intended purpose, improvements in door protection devices would be well-received in the art.

### BRIEF DESCRIPTION OF THE DRAWINGS

Referring now to the drawings wherein like elements are numbered alike in the several FIGURES:

FIGS. 1A, 1B, 2A and 2B depict a conventional elevator door retention apparatus;

FIGS. 3-5 depict another conventional elevator door retention apparatus;

FIG. 6 is a front view of an elevator door system in an exemplary embodiment;

FIG. 7 is a cross-sectional view of an elevator door system in an exemplary embodiment;

FIG. 8 depicts guide brackets in an exemplary embodiment; and

FIG. 9 is a perspective view of an elevator door system in an exemplary embodiment.

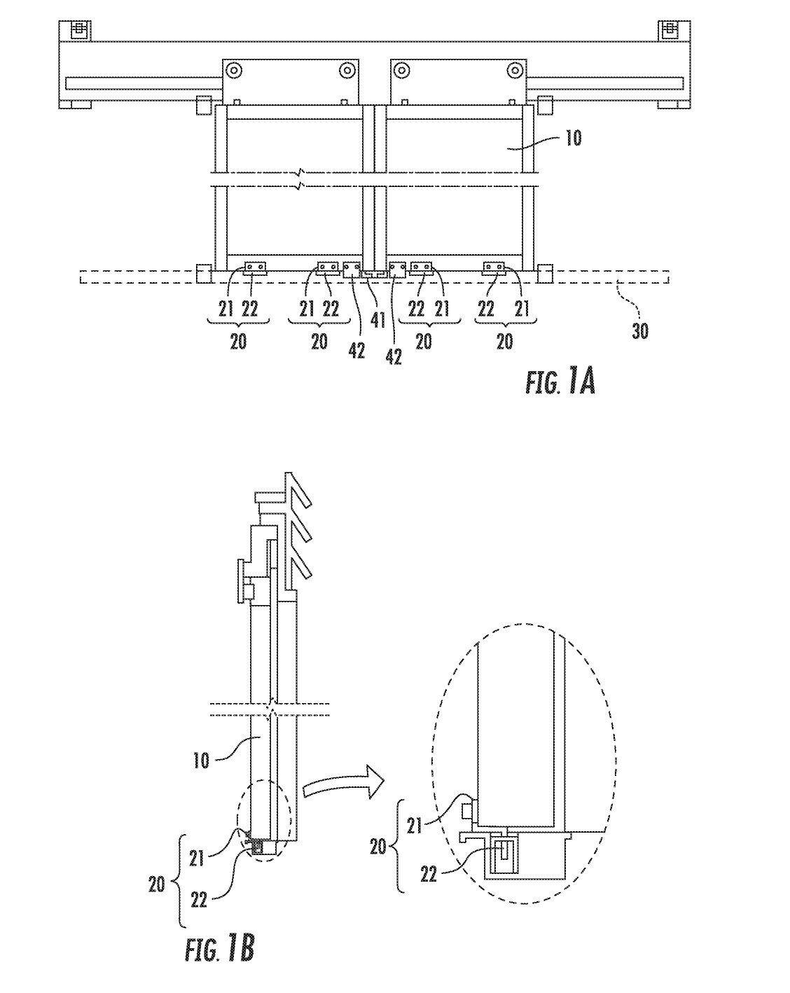

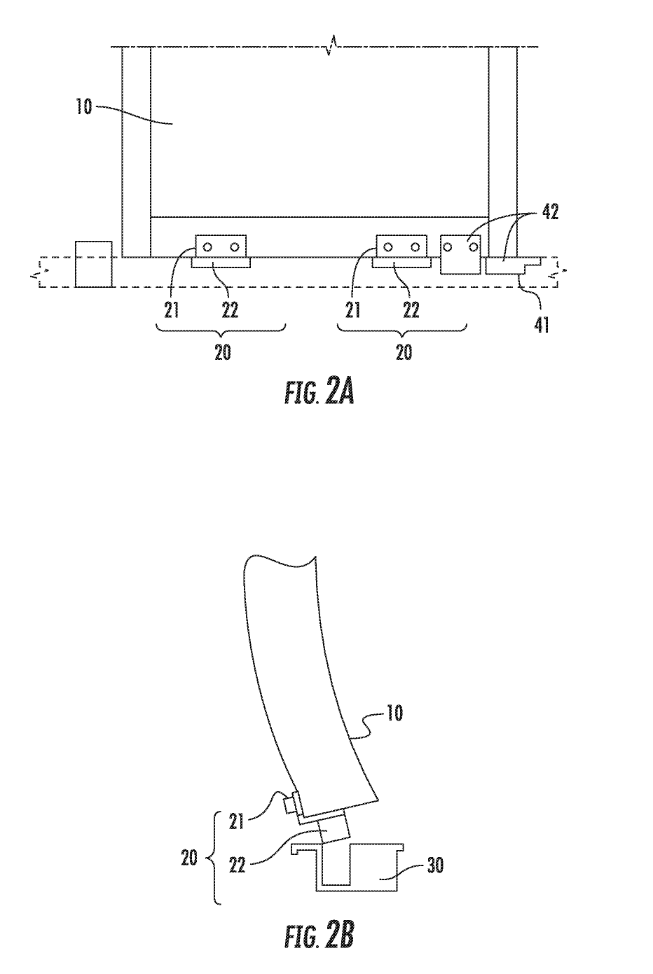

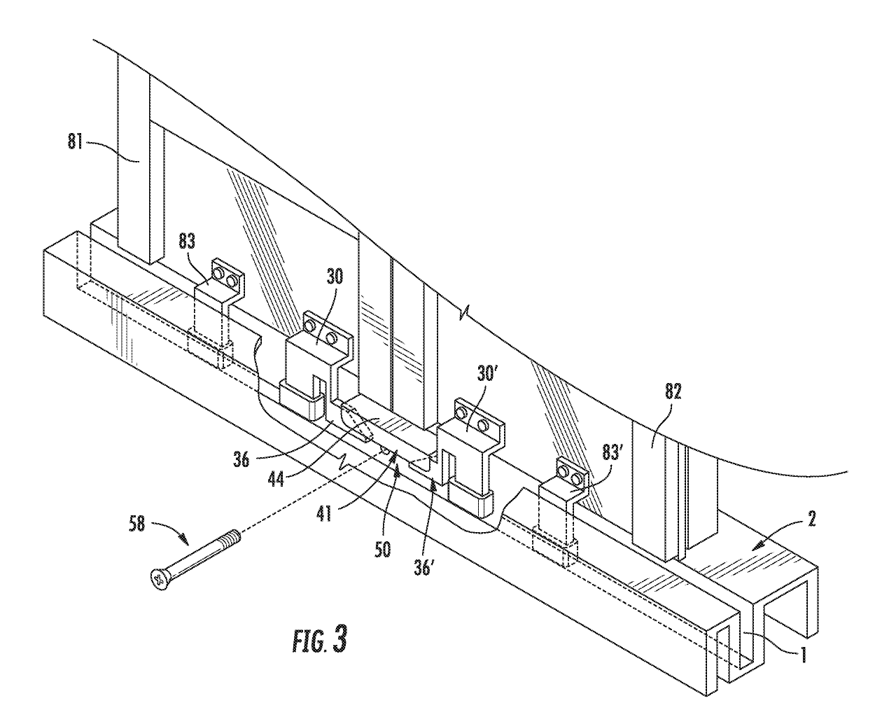

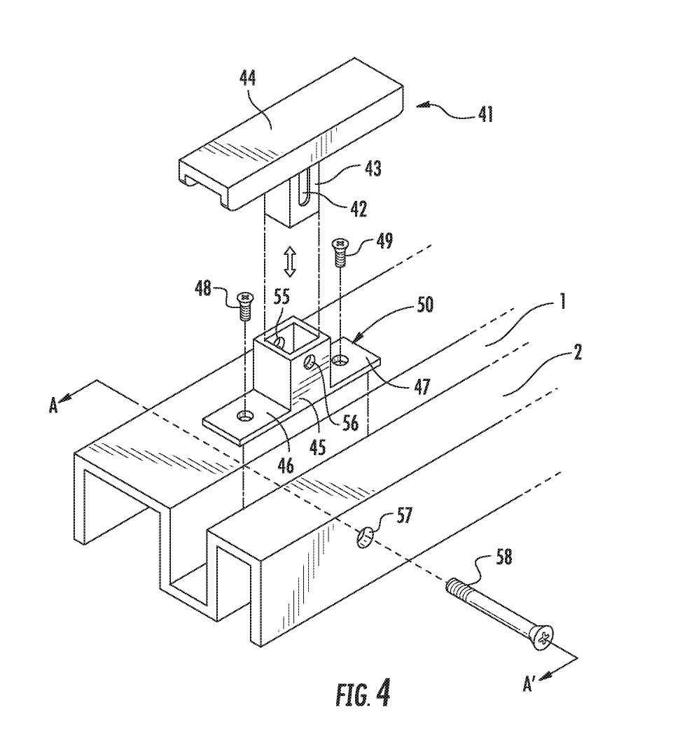

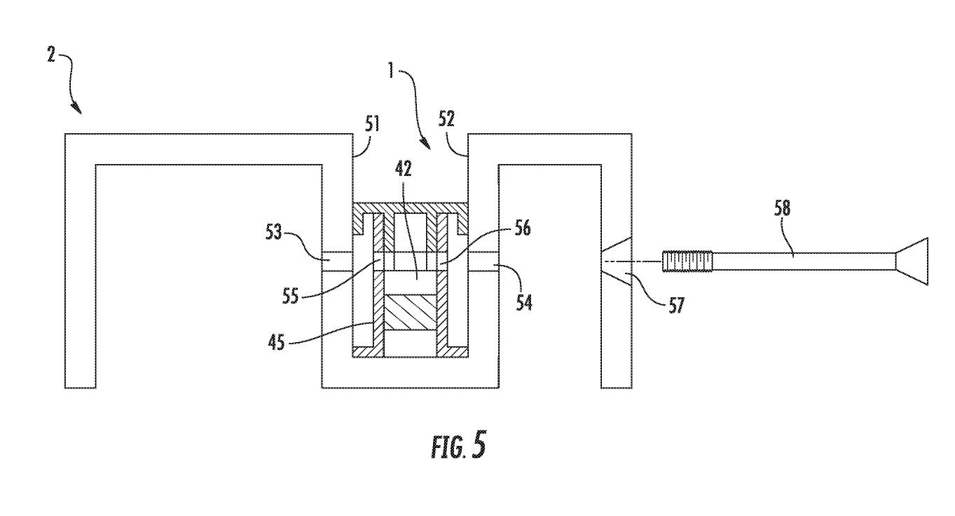

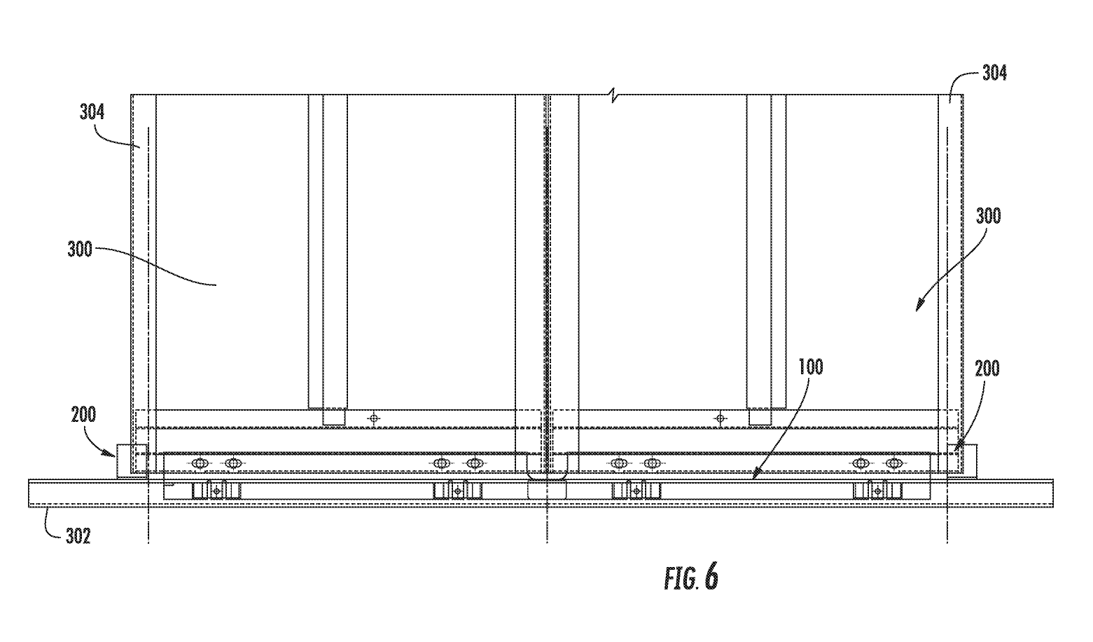

### DETAILED DESCRIPTION

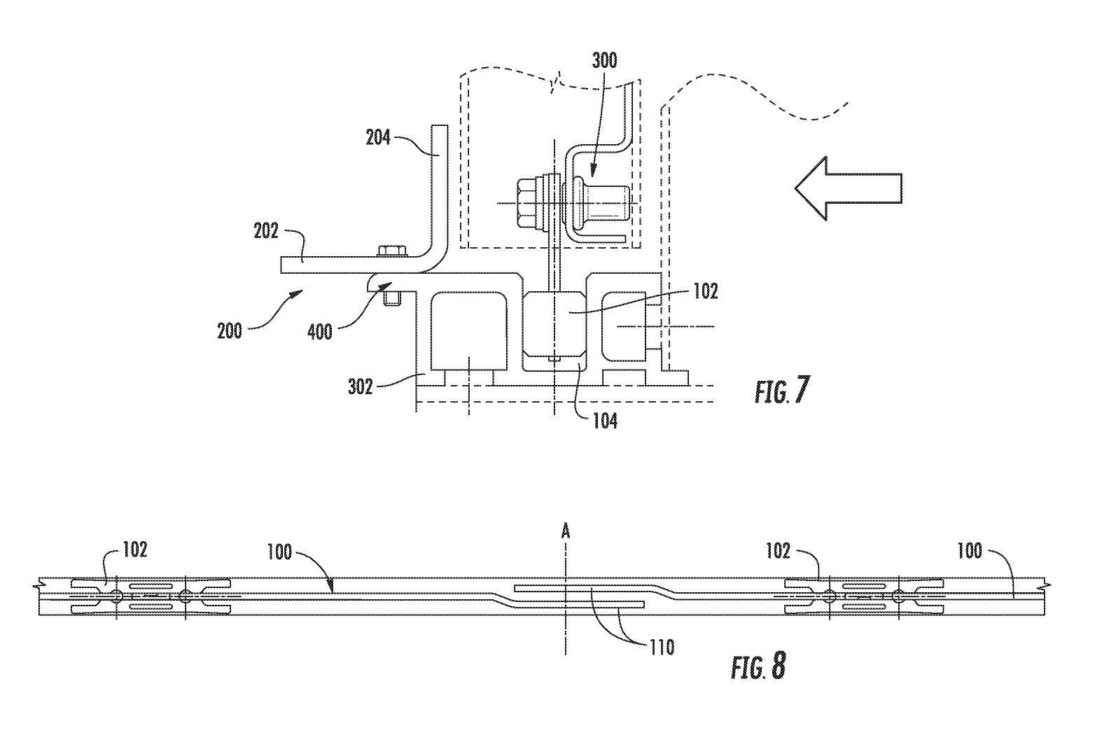

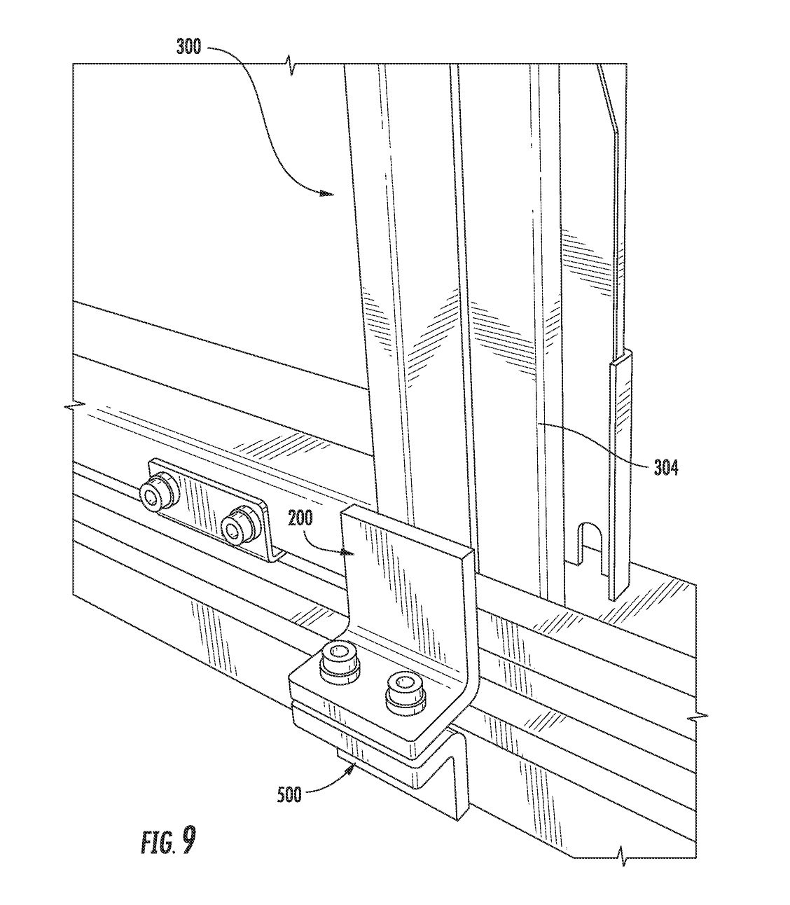

FIG. 6 is a front view of an elevator door system in an exemplary embodiment. The elevator door system includes elevator landing doors 300. The elevator landing doors 300 are positioned in a hoistway opening and are supported on hanging rollers, as known in the art. A guide bracket 100 is secured to the bottom of each door 300 and travels in a groove 104 (FIG. 7) of a threshold 302. The guide brackets 100 help to retain the doors 300 in position if force is applied against the front surface of the doors 300. One or more guide shoes 102 (FIGS. 7 and 8) may be mounted to each guide bracket 100 to center each guide bracket 100 in the groove 104 in the threshold 302.

As shown in FIG. 8, each guide bracket 100 has a distal end 110, at which the guide brackets 100 overlap. This overlap may be centered on an axis, A, corresponding to a location where the doors 300 abut in the closed position. The overlapping distal ends 110 of the guide brackets 100 provide enhanced resistance to force applied to the doors 300 in a direction perpendicular to the open/close direction of doors 300. This keeps the guide brackets 100 in groove 104 and prevents doors 300 from being forced into the hoistway.

Referring to FIG. 6, another device to aid in retention of the doors 300 are retention brackets 200. The retention brackets 200 are positioned proximate to door jambs 304 to aid in preventing doors 300 for being forced into the hoistway. As shown in FIG. 7, the threshold 302 includes a lip 400 that extends away from the threshold 302 and doors 300 and inwards towards the hoistway. The retention bracket 200 includes a base 202 that is secured to the lip 400 (e.g., by a fastener). The retention bracket 200 includes a flange 204 extending perpendicular to base 202, extending vertically behind the doors 300. The retention bracket 200 resists force applied against the front of door 300 (as shown in the arrow in FIG. 7). If a door 300 is pushed with sufficient force, the door 300 will contact the retention bracket 200 to prevent the guide bracket 100 from being dislodged from groove 104.

FIG. 9 depicts another embodiment where the retention bracket 200 is mounted to a support bracket 500. The support bracket 500 may be a right angled bracket having a first leg secured to threshold 300 (e.g., by a fastener) and a second leg that extends into the hoistway. The retention bracket 200 is mounted to the support bracket 500 (e.g., by a fastener).

The terminology used herein is for the purpose of describing particular embodiments only and is not intended to be limiting of the invention. While the description of the present invention has been presented for purposes of illustration and description, it is not intended to be exhaustive or limited to the invention in the form disclosed. Many modifications, variations, alterations, substitutions, or equivalent arrangement not hereto described will be apparent to those of ordinary skill in the art without departing from the scope and spirit of the invention. Additionally, while the various embodiment of the invention have been described, it is to be understood that aspects of the invention may include only some of the described embodiments. Accordingly, the invention is not to be seen as limited by the foregoing description.

What is claimed is:

1. An elevator door system comprising:
at least one elevator door;
a guide bracket mounted to a bottom of the at least one elevator door;
a threshold having a groove to receive the guide bracket;
a retention bracket coupled to the threshold, the retention bracket positioned in a hoistway and behind the door, the retention bracket located proximate to a door jamb.

2. The elevator door system of claim 1 wherein:
the threshold includes a lip extending towards the hoistway;
the retention bracket secured to the lip.

3. The elevator door system of claim 1 further comprising:
a support bracket secured to the threshold;
the retention bracket secured to the support bracket.

4. The elevator door system of claim 1 wherein:
the at least one elevator door comprises two elevator doors;
the retention bracket comprises two retention brackets, each retention bracket positioned the hoistway and behind a respective door proximate to a respective door jamb.
